(19) United States
(12) Patent Application Publication
(10) Pub. No.: US 2010/0147974 A1
(43) Pub. Date: Jun. 17, 2010

(54) Door Handle and Door Handle Cleaner

(76) Inventors: Brian Cunningham, Dublin (IE); Rosemarie Cunningham, Dublin (IE)

Correspondence Address: STANDLEY LAW GROUP LLP, 6300 Riverside Drive, Dublin, OH, 43017, US

(21) Appl. No.: 12/600,672

(22) PCT Filed: May 5, 2008
(86) PCT No.: PCT/EP2008/003864

§ 371 Date: Nov. 18, 2009

(30) Foreign Application Priority Data
May 18, 2007 (IE) S2007/0363

(51) Int. Cl. A62C 31/28; E06B 7/00

(52) U.S. Cl. 239/274; 16/412

(57) ABSTRACT

A cleaning apparatus (100) for cleaning a door handle (103) mounted on a door (101), comprising a cleaning means (102) which in use is operatively connected to a door to apply a disinfectant to the door handle surface when the door is opened or closed. The cleaning means (102) comprises a reservoir of disinfectant liquid (105) and a spray head (102) to spray the disinfectant liquid onto the handle (103) when the door is opened or closed. The spray head (102) is operated by an actuating means (128, 150).

The present invention relates to a door handle and door handle cleaner and in particular to a self cleaning door handle. The invention in particular relates to a toilet door handle.

With the spread of disease and infection from surfaces, such as door handles, which are contacted by many individuals a need arises for the regular cleaning or disinfection of such surfaces. In particular this problem arises in hospitals and other establishments where there is likely to be a considerable amount of bacteria or other germs. The problem arises also in public bathrooms and toilets where some individuals fail to wash their hands. In view of this concern many individuals try to open doors, particularly toilet doors with the minimum amount of hand contact with the door.

According to the invention there is provided a cleaning apparatus for cleaning a door handle mounted on a door, comprising a cleaning means which in use is operatively connected to a door to apply a disinfectant to the door handle surface when the door is opened or closed. The apparatus comprises a means for applying a disinfectant to the door handle surface as the door is opened or closed. Preferably, a disinfectant is applied to the door handle surface each time the door is closed.

Preferably, the cleaning means comprises a reservoir of disinfectant liquid and a spray head to spray the disinfectant liquid onto the handle when the door is opened or closed.
The spray head is preferably operated by an actuating means.
The actuating means preferably comprises an actuating member which is operatively associated with the door frame, such that opening or closing of the door causes movement of the actuating member to operate the spray head.
A cam member is in use preferably provided on the door frame to move the actuating member to operate the spray head.
Preferably, the actuating member is in use spring urged against the cam member.
Preferably, the length of the actuating member is adjustable.
The actuating member is preferably hollow and the reservoir of disinfectant is connected to the spray head by a conduit located within the actuating member.
The spray head preferably comprises a pair of spray outlets in use disposed above the door handle.
The spray outlets are preferably directed at opposite sides of the door handle.
Preferably, the door handle is elongate.
The door handle is preferably freely rotatable.
In one embodiment preferably, a cleaning element is provided on the door handle, and means is provided to move the cleaning element over the door handle surface.
The cleaning element may be annular, and a retaining means is provided to hold the cleaning element in an upper position, the retaining means being released on closing of the door, such that the cleaning element moves downwardly under gravity to wipe the door handle surface.
The invention further provides a door handle apparatus for mounting on a door comprising a base member and a handle member, wherein the handle member is mounted on the base member so as to be freely rotatable.

In another embodiment the disinfectant is applied by moving a cleaning element across the door handle.

The cleaning element may be in the form of a cleaning pad which is moistened with a liquid disinfectant or with a spray of disinfectant.

The cleaning pad is preferably treated with a disinfectant each time the door is opened or closed. Alternatively, the cleaning pad is treated with a disinfectant on an intermittent basis. The disinfectant may be applied on a time control system.

Preferably, the door handle is elongate and is mounted on the door on the inside part of the door relative to the room, for example the toilet or bathroom.

The cleaning pad is preferably moved along the door handle by a mechanical system operated by the opening or closing movement of the door.

The mechanical system preferably comprises a cleaning pad which is retained in a top position and which is released on closing of the door, to move downwardly under gravity to wipe the handle surface.

Preferably, a spring means is provided to return the cleaning pad to the top position.

Alternatively, a ratchet mechanism may be provided to move the cleaning pad between a lower position and an upper position, or vice versa.

Embodiments of the invention will now be described, by way of example, with reference to the accompanying drawings, in which;

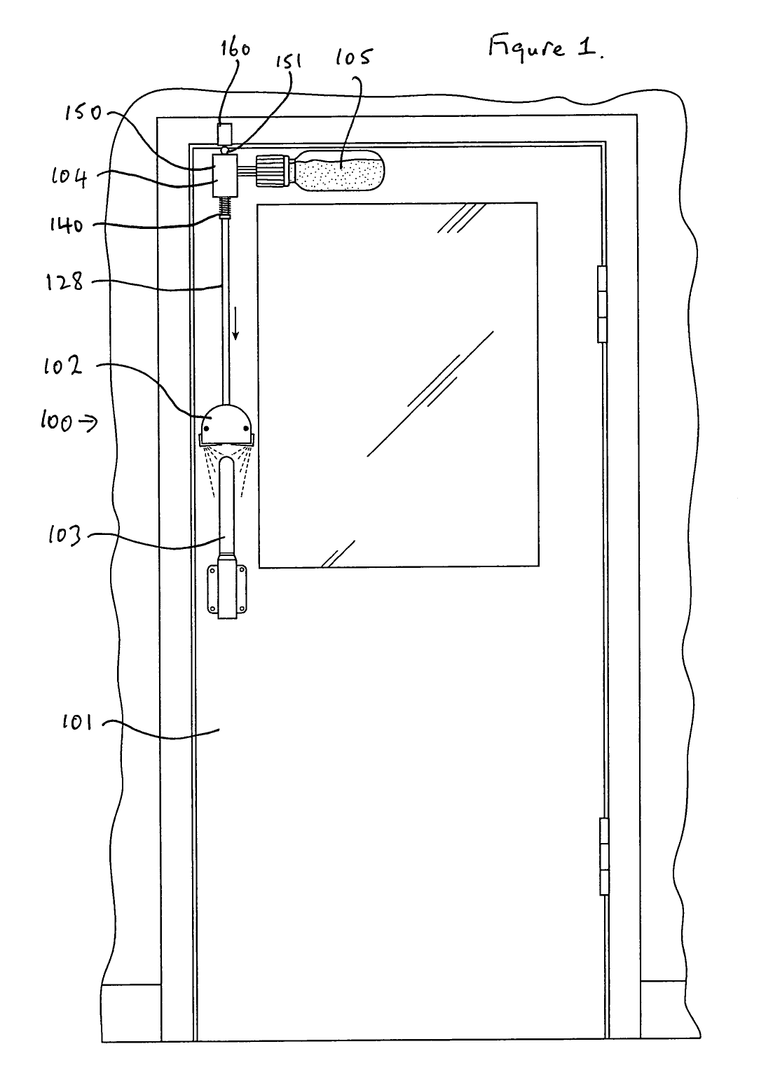

FIG. 1 is a front view of an embodiment of a cleaning apparatus according to the invention;

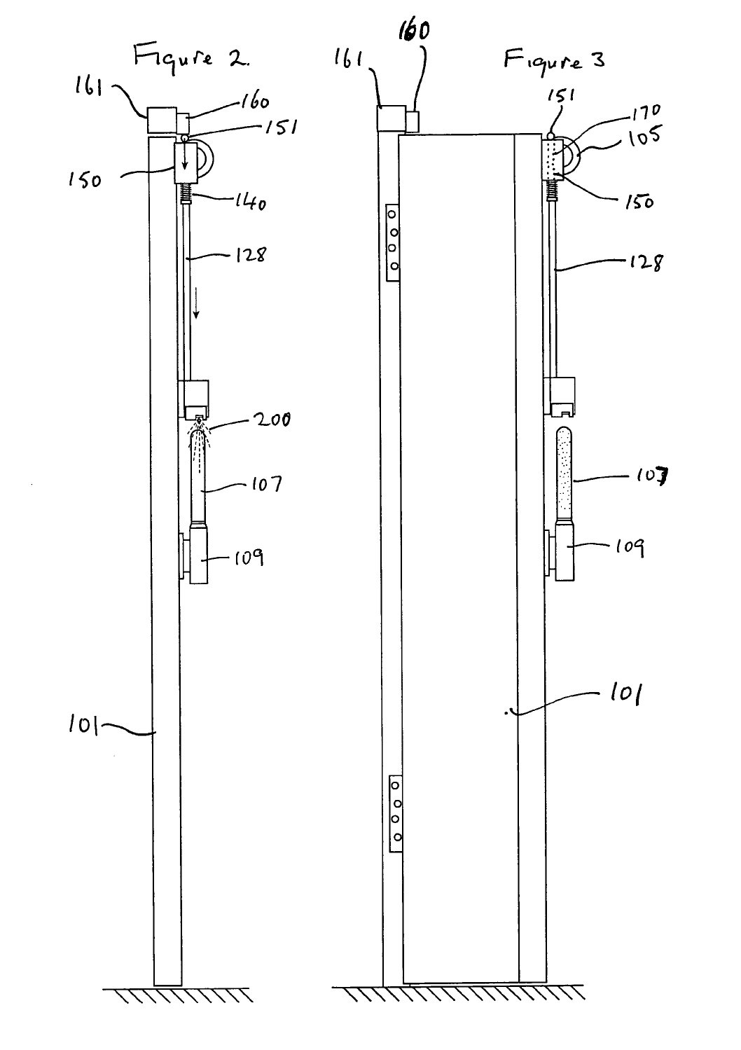

FIG. 2 is a side view of the apparatus of FIG. 1, with a door in the closed position;

FIG. 3 is a side view of the apparatus of FIG. 1 with the door in an open position;

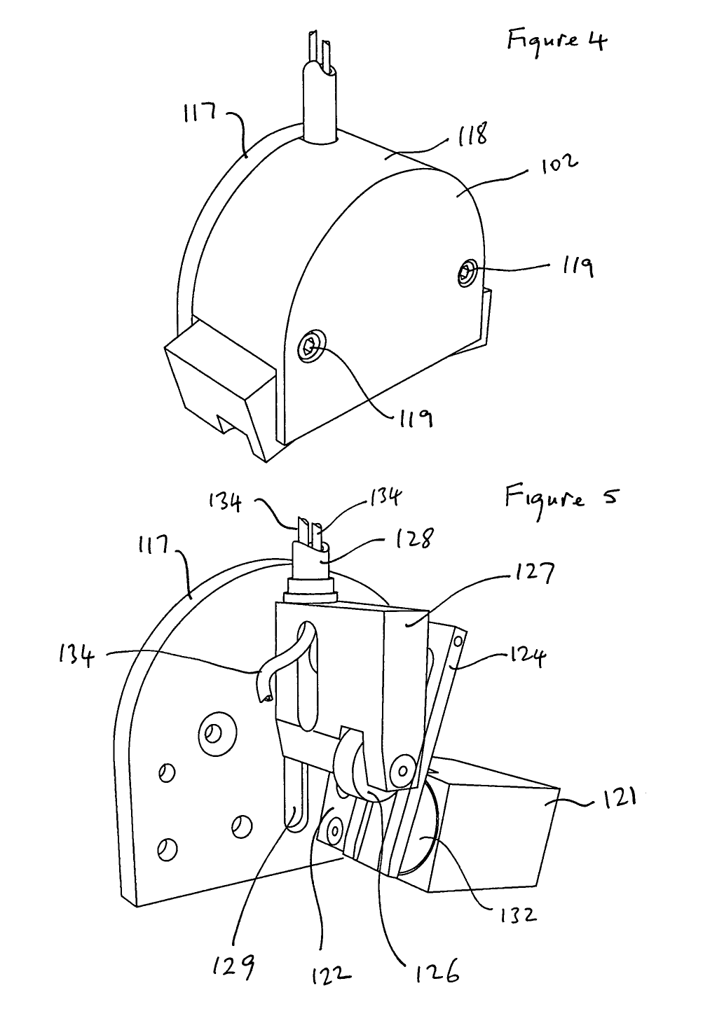

FIG. 4 is a perspective view of a spray head of the apparatus of FIG. 1;

FIG. 5 is a partial view of the spray head of FIG. 4 with the cover removed;

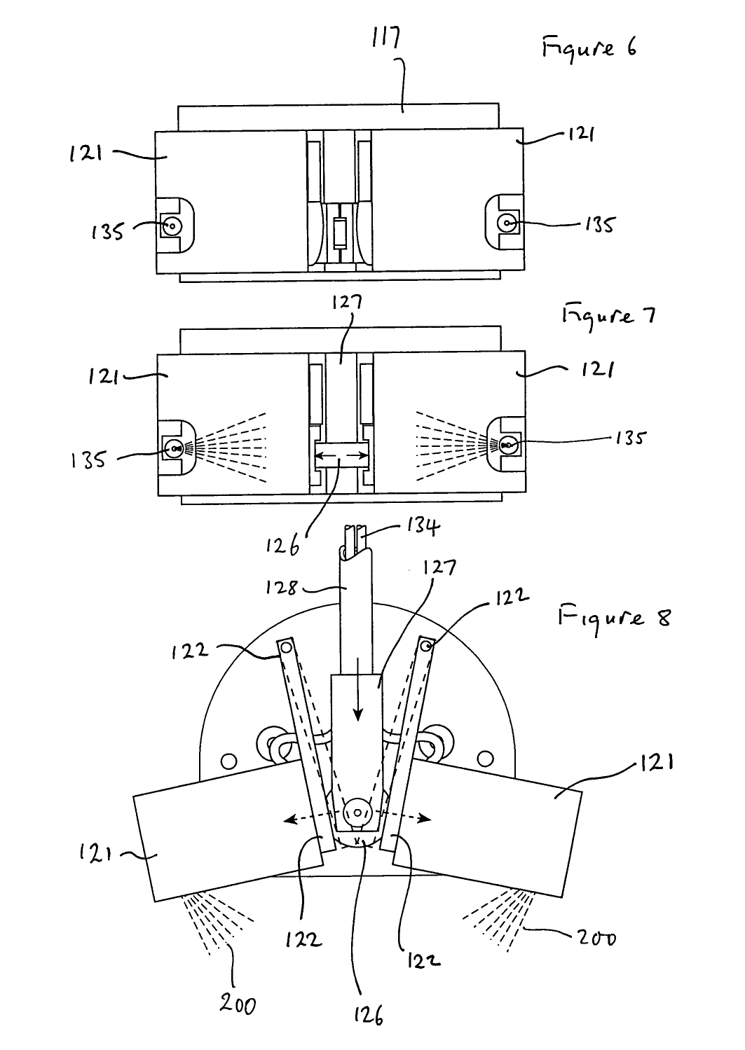

FIG. 6 is an underneath plan view of the spray head of FIG. 4 in a non-operative position;

FIG. 7 is an underneath plan view of the spray head of FIG. 4 in an operative position;

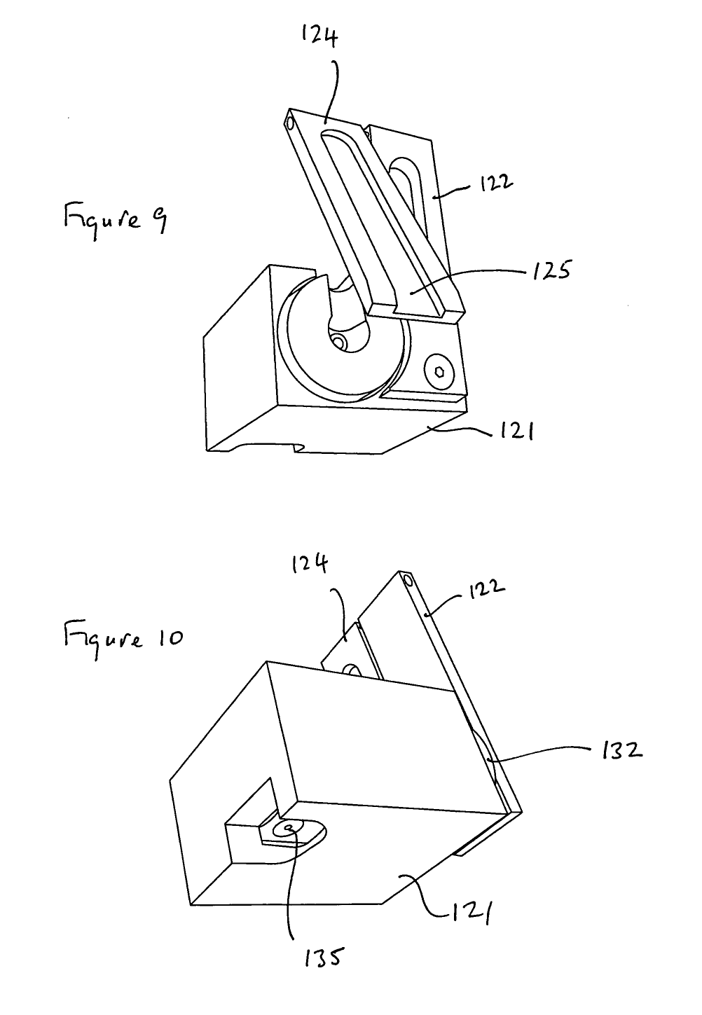

FIG. 8 is a front view of the spray head in an operative position;

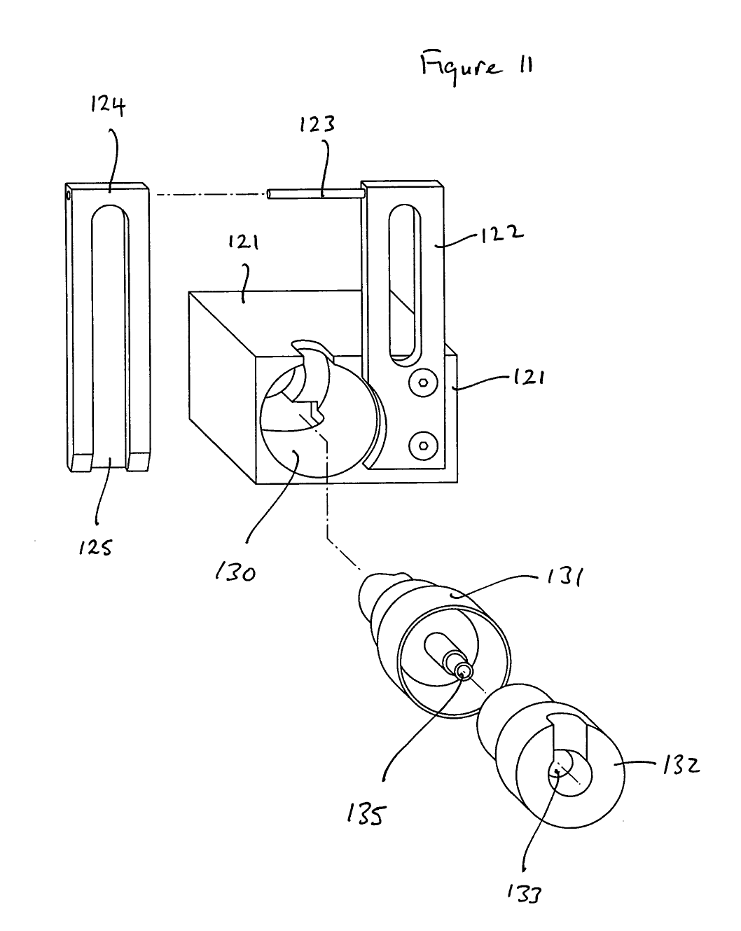

FIGS. 9 and 10 are perspective views of a housing for the spray nozzle;

FIG. 11 is an exploded perspective view of the spray nozzle and housing;

FIG. 12 is a perspective view of a door handle apparatus according to an aspect of the invention;

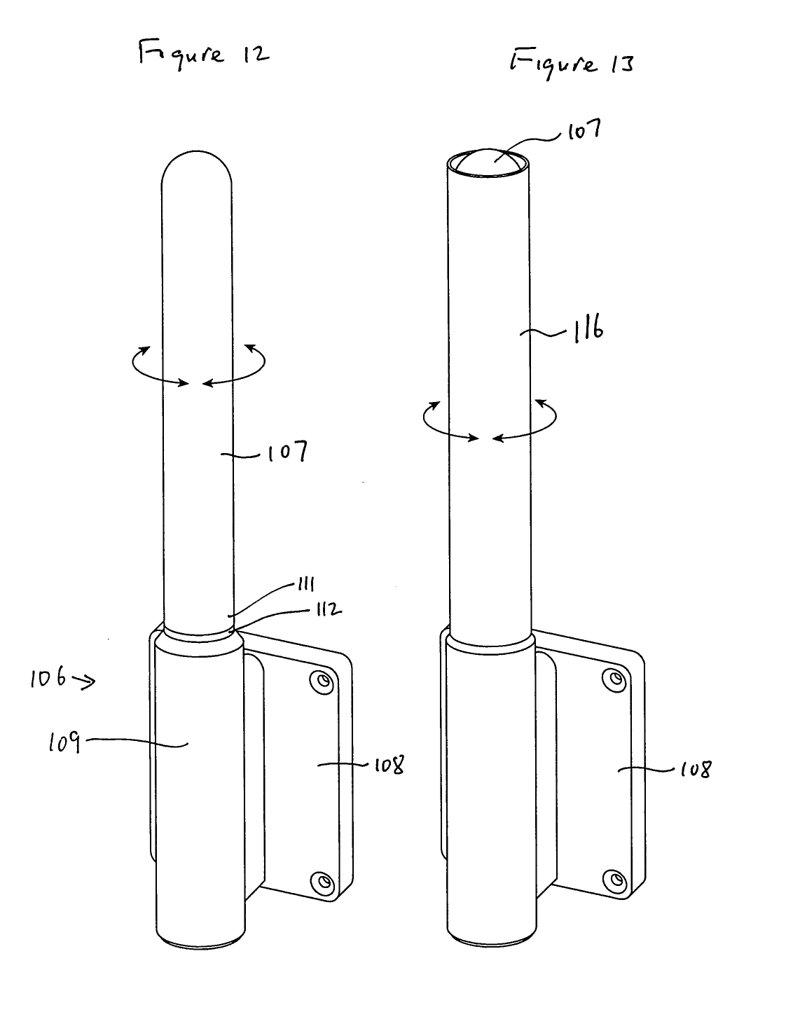

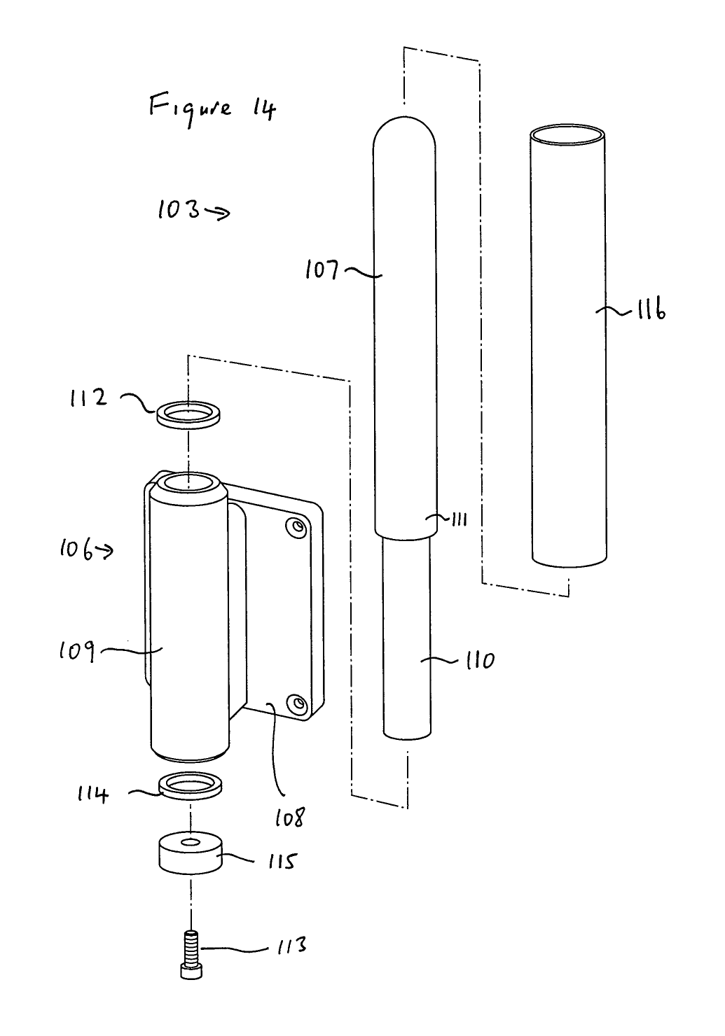

FIG. 13 is a perspective view of another embodiment of a door handle apparatus according to the invention;

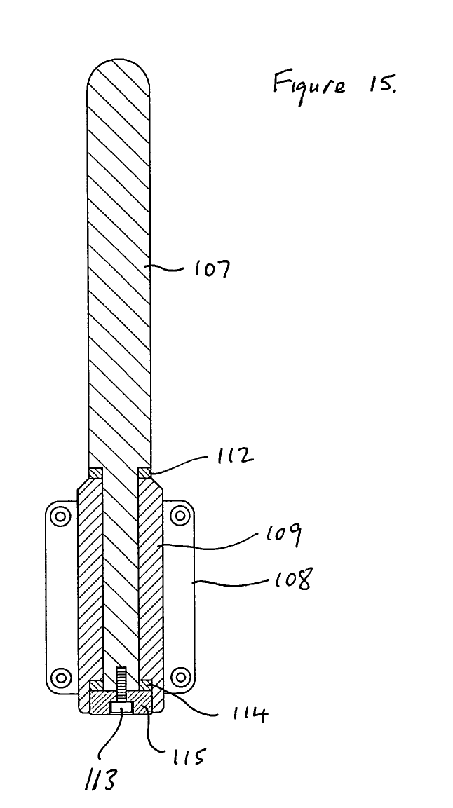

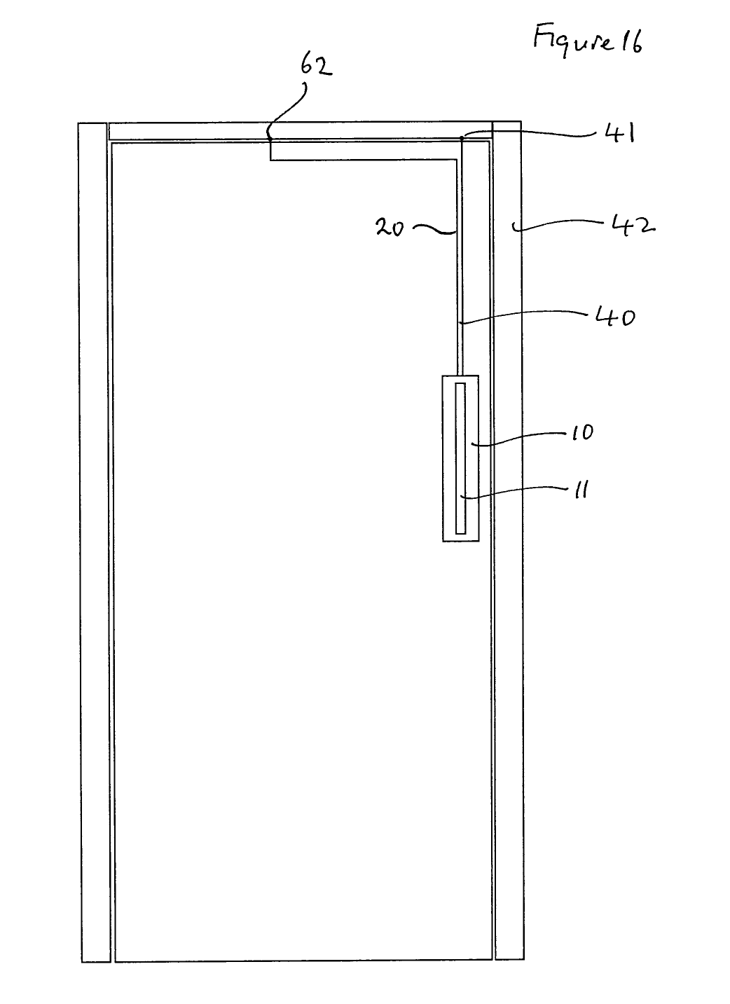

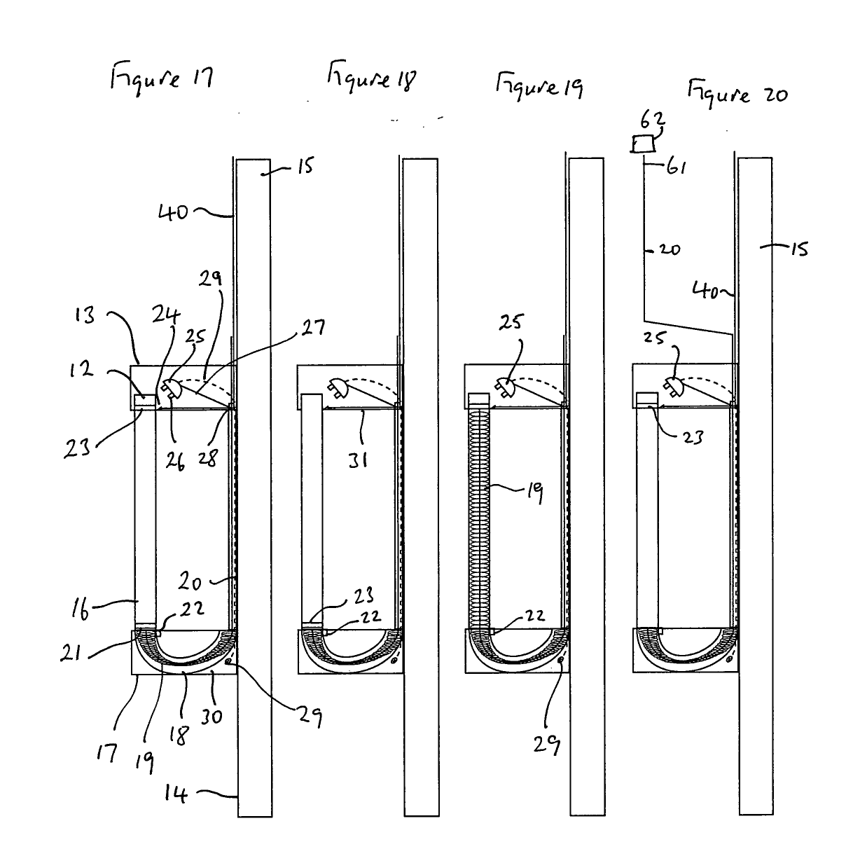

FIG. 14 is an exploded view of the door handle apparatus of FIG. 12;

FIG. 15 is a cross-sectional view of the door handle apparatus of FIG. 12.

FIG. 16 shows a self cleaning door handle apparatus mounted on a door, according to the invention;

FIG. 17 is a sectional view of the door handle apparatus of FIG. 16;

FIG. 18 illustrates the operation of the door handle apparatus of FIG. 17;

FIG. 19 illustrates the operation of the door handle apparatus of FIG. 17; and

FIG. 20 illustrates the operation of the door handle apparatus of FIG. 17;

Referring now to FIGS. 1 to 15 there is shown therein a cleaning apparatus 100 for cleaning a door handle mounted on a door 101. The apparatus 100 comprises a spray head 102 mounted above a door handle apparatus 103. The spray head 102 is operatively connected to an actuating means 104 and a reservoir 105 of disinfectant liquid also mounted on the door 101.

Referring now to FIGS. 12 to 15 there is shown therein a door handle apparatus 103 comprising a base member 106 and a handle member 107. The base member 106 comprises a bracket 108 for securing to the door, and a hollow mounting collar 109, for receiving a tubular section 110 of the handle member 107. A lower end 111 of the handle member 107 abuts a nylon washer 112 and a tubular section 110 is secured in the collar 109 by a nut 113 and a washer 114 and bushing 115, in such a manner that the handle member 107 is freely rotatable in either direction about its axis on the collar 109. The handle member can therefore be continually rotated, in either direction and no stop is provided or necessary.

A sleeve 116 of a copper material may optionally be fixed in place over the handle member 107. Copper is known as an antibacterial material but other materials, may also be suitable. As a user grips the handle member 107 to open the door, the handle member 107 will rotate a certain amount so that a different part of the handle is contacted the next time the door is opened. The relevance of this will be described further below.

Referring now to FIGS. 4, 5, 8 and 11, the spray head 102 comprises a base 117 and a removable cover 118 which is secured in place by bolts 119. Within the spray head 102 there is provided a pair of spray nozzles 131. Each spray nozzle 131 is mounted in a housing 121 which is mounted to the base 117, by a bracket 122. Each bracket 122 has pivoted thereon by means of a rod 123 a further bracket 124. The bracket 124 has a groove 125 to accommodate a wheel or cam 126 mounted on a block 127 connected to an actuating member or rod 128. The base 117 has a guide slot 129 to accommodate a sidewall of the block 127 to enable the block 127 to move vertically upwards and downwards within the limits of the slot 129.

Each housing 121 has an annular recess 130 to accommodate a spray nozzle 131 and a boss 132. The boss 132 has a hole 133 through which a tube or conduit 134 is inserted to connect to the nipple 135 of the spray nozzle 131. The tube 134 which passes through the hollow interior of the actuating member or rod 128 is connected at the top of the door 101 to the reservoir 105.

The tube 134 preferably comprises silicon tubing which is particularly flexible. The silicon tube 134 preferably has an 0.8 mm bore which has been found to provide the optimum flow to the nozzle from the reservoir 105 each time the spray nozzle 131 is actuated, and this size of tubing is also very effective in priming the spray nozzle when the reservoir is first connected to the tubing and air has to be expelled from the tubing 134 through the spray nozzle 131. Further, depending on the type and size of spray nozzle 131 used, it may be necessary to connect the tubing 134 in conventional manner, to a short length of another silicon tubing (not shown) to connect to the nipple 135. In the present case the short length of silicon tubing has a bore of 1.6 mm for connecting to the nipple 135.

It will be clear that in use each bracket 124 abuts the respective boss 132 so that if the bracket 124 pushes the boss inwards into the recess 130 the nozzle 131 is actuated to emit a spray of liquid as indicated in FIGS. 7 and 8 from the nozzle opening 135.

Thus, vertical downward movement by the actuating member 128 pushes the block 127 downwards, causes the wheel or cam 126 to push against the brackets 124, which in turn push the bosses 132 outwardly to activate the nozzles 131. The actuating rod 128 is spring urged upwardly by a spring means 140 to a raised position in which there is no force on the brackets 124.

Mounted adjacent to the top of the door 101 is a block 150 which is adjustable vertically and which accommodates the end of the rod 128. The spring means 140 could be accommodated, if desired within the block 150. Mounted on top of the block 150 is a cam or roller 151. A further cam member 160 is mounted on the door frame 161 just above the block 150.

Referring in particular to FIGS. 2 and 3 it will be clear that in the open position of the door the spring means 140 urges the block 150 to an uppermost position in which the rod 128 and block 127 are in their uppermost position and no pressure is exerted on the spray nozzles 131 by the brackets 124.

However, when the door is closing the roller or cam 151 abuts the underside of the cam member 160 mounted on the door frame, so that the block 150 and rod 128 are pushed downwardly against the bias of the spring 140, so that the block 127 in the spray head 102 activates the nozzles 131 and causes a spray of disinfectant fluid to be directed over the handle 107. As shown in FIGS. 7 and 8 since the nozzles 131 are positioned above and are directed downwardly and inwardly towards the handle 107, a spray 200 of the liquid is directed onto the handle 107.

When the door is next opened, the rod 128 again moves upwardly so that the spray nozzles are again ready to operate when the door closes again.

Therefore, each time the door closes a spray 200 of liquid is directed onto the handle 107.

It will be appreciated that the spray head may be operated by any suitable form of actuating means. Thus, the actuating member 128 may be operated by having it operatively associated with the door frame, or in any other preferred way, so that opening or closing of the door causes the spray head to activate and spray a jet of disinfectant liquid onto the door handle.

Also, when a user grips the handle 107 to open the door, and then releases the handle 107, the handle 107 will rotate a little, so that each time the spray head activates, a different portion of the handle will be brought into alignment with the spray from the spray head. However, it will also be appreciated that since the spray from the nozzles 135 will be in the form of a cone type pattern, even if the handle 107 did not rotate the complete handle will receive an application of the disinfectant spray.

Further, it will be appreciated, that the block 150 will be mounted on the door 101 for slideable vertical movement as the door is opened and closed. Alternatively, it will be appreciated that the cam or roller 151 may be attached to the top of the rod 128, so that the rod 128 may move vertically within the block 150. In this case, the block 150 will be hollow or will have a cylindrical channel 170 to accommodate the uppermost end of the rod 128 to facilitate upward or downward movement of the rod 128.

Referring now to the FIGS. 16-20 there is shown therein another embodiment of a door handle apparatus 10 according to the invention. The door handle apparatus 10 comprises a door handle 11 in the form of an elongate cylinder. The upper end 12 of the door handle 11 is mounted in a hollow housing 13 which in turn is fixed to the inside surface 14 of a door 15. Similarly, the lower end 16 of the door handle 11 is mounted to a hollow enclosure 17 which is fixed to the inside surface 14 of the door 15.

The housing 17 includes a conduit 18 for a coil spring 19 which is connected to a cable 20. The end of the coil spring 19 is provided with a plate 21. A spring loaded catch 22 is provided at the lower end 16 of the handle 11 so as to retain the coil spring 19 in a compressed state within the conduit 18.

An annular cleaning head 23 is provided on the handle 11 and is free to move upwardly and downwardly on the handle 11 to clean the handle surface. The cleaning head 23 may comprise a cloth material or pad or alternatively may comprise a brush type cleaning head including a plurality of bristles. A spring loaded catch 24 is located at the top end 12 of the door handle 11 to retain the cleaning head 23 in the upward position as shown in FIG. 17.

A housing 25 is provided in the enclosure 13 and contains two nozzles 26. The housing 25 is attached to an operating arm 27 which is pivoted at coupling 28. The housing 25 is connected to a feed tube 29 which is connected to a reservoir 30 of disinfectant fluid in the housing 17.

The spring loaded catch 24 is attached to an arm 31 which is moved horizontally to release the catch 24 thereby allowing the pad 23 to fall downwardly along the handle and clean the handle surface by wiping it. The feed tube 29 supplies disinfectant liquid from the reservoir 30 to the housing 25 which directs a spray of the liquid through the nozzles 26 onto the pad 23. The arm 27 serves to operate the nozzles 26 so that when the arm 27 is moved it activates the housing 25 to provide a spray of liquid on to the pad 23. The housing 25 and arm 27 are arranged to operate in a similar fashion to a conventional liquid spray operated by depressing the actuator of a container containing liquid.

A lever 40 is mounted on the door and is connected to the coupling 28 and is spring urged upwardly, by a spring (not shown) in the coupling. The lever 40 projects very slightly above the top of the door to engage the top 41 of the door frame 42 when the door is in a closed position. In this position the spring loaded lever 40 is moved downwards on making contact with the door frame (or on making contact with a bracket [not shown] attached to the door frame).

As the lever 40 is pushed downwards, it pulls with it lever 27 and arm 31. This in turn causes housing 25 to activate and the nozzles 26 spray disinfectant fluid on to the handle 11 and the cleaning pad 23. At the same time the spring loaded catch 24 is moved to release the cleaning pad 23 so that it may fall downwardly along the handle FIG. 18 thus spreading the disinfectant fluid, along the handle surface to clean and disinfect it.

It will be noted that the cleaning head 23 may be attached to the handle 11 by means of one ring inside the handle and one on the outside with the rings connected by a flange projecting through a slot (not shown) in the handle 11.

As the cleaning head 23 falls freely down the handle 11 the ring inside the handle makes contact with the catch 22 so that as the catch 22 is moved it releases compressed spring 19 which then extends back up through the hollow handle 11 pushing the cleaning head 23 back up along the handle 11 and forcing it into a primed position once again to be retained in place with the catch 24, FIG. 19.

As shown the plate 21 of the spring 19 is attached to a cable 20 which is connected along the door but the end 61 is attached to the door frame at 62. As the door is opened, with the cable attached to the door frame, the spring 19 is retracted into conduit 18 and compressed again until it is retained by the spring loaded catch 22, which engages with the handle 11, FIG. 18.

The invention provides a simple, reliable and inexpensive cleaning apparatus for a door handle which has application in a number of environments including hospitals and restaurants, hotels, theatres etc. The invention will serve to reduce the spread of bacteria and infection by reducing or eliminating contamination on surfaces commonly touched by individuals, and in particular door handles in toilets and restrooms.

It will be appreciated that other mechanical systems for example a ratchet mechanism may be employed to move a cleaning head over a handle surface. Also, suitable electronic or electrical apparatus may be employed to move a cleaning element over a handle surface and other modifications are envisaged, if desirable including timing systems to intermittently wipe a handle or drying apparatus.

The invention is not limited to the embodiment(s) described herein but can be amended or modified without departing from the scope of the present invention.

1. A cleaning apparatus for cleaning a door handle mounted on a door, comprising:
a cleaning means which in use is operatively connected to a door to apply a disinfectant to the door handle surface, the cleaning means comprising a reservoir of disinfectant liquid and a spray head to spray the disinfectant liquid onto the handle when the door is opened or closed; and
an actuating means to operate the spray head.

2-3. (canceled)

4. The cleaning apparatus as claimed in claim 1 wherein the actuating means comprises an actuating member which is operatively associated with the door frame, such that opening or closing of the door causes movement of the actuating member to operate the spray head.

5. The cleaning apparatus of claim 4, further comprising:
a cam member, located on the door frame to move the actuating member to operate the spray head.

6. The cleaning apparatus of claim 5; further comprising:
a spring that urges the actuating member against the cam member.

7. The cleaning apparatus of claim 4 wherein the length of the actuating member is adjustable.

8. The cleaning apparatus of claim 4 wherein the actuating member is hollow and the reservoir of disinfectant is connected to the spray head by a conduit located within the actuating member.

9. The cleaning apparatus of claim 2 wherein the spray head comprises a pair of spray outlets in use disposed above the door handle.

10. A cleaning apparatus as claimed in claim 9 wherein the spray outlets are directed at opposite sides of the door handle.

11. A cleaning apparatus as claimed in claim 10 wherein the door handle is elongate.

12. A cleaning apparatus as claimed in claim 11 wherein the door handle is freely rotatable.

13. A cleaning apparatus as claimed in claim 11 wherein a cleaning element is provided on the door handle, and means is provided to move the cleaning element over the door handle surface.

14. A cleaning apparatus as claimed in claim 13 wherein the cleaning element is annular, and a retaining means is provided to hold the cleaning element in an upper position, the retaining means being released on closing of the door, such that the cleaning element moves downwardly under gravity to wipe the door handle surface.

15. A door handle apparatus for mounting on a door comprising a base member and a handle member, wherein the handle member is mounted on the base member so as to be freely rotatable.
